(19) United States
(12) Patent Application Publication
(10) Pub. No.: US 2026/0219843 A1
(43) Pub. Date: Jul. 30, 2026

(54) TECHNIQUES FOR OPTIMIZING APPLICATION DEVELOPMENT ON A CELLULAR NETWORK

(71) Applicant: T-Mobile USA, Inc., Bellevue, WA (US)

(72) Inventors: Suneetha Thomas, Bellevue, WA (US); Murugappan Palaniappan, Issaquah, WA (US); Rajesh Shrivastava, Bellevue, WA (US)

(21) Appl. No.: 19/038,317

(22) Filed: Jan. 27, 2025

(51) Int. Cl. G06F 8/30

(52) U.S. Cl. CPC G06F 8/30

(57) ABSTRACT

Techniques are described herein for optimizing service implementation within application development for a network. In embodiments, the techniques may involve storing, in a data repository, a set of frameworks, an individual framework of the set of frameworks associated with a service. Upon receiving a request to access the service from a software application, the techniques may comprise providing, in response to the request, a service identifier value that uniquely identifies the individual framework. The techniques may, at a later point in time, receiving, from the software application during its execution, the service identifier value, and executing the service based on a service name associated with the individual framework.

### BACKGROUND

Cellular networks have evolved greatly over recent years. One of the most recent changes in cellular networks is the adoption of the fifth-generation (5G) technology standard for broadband cellular networks. The adoption of the 5G technology standard by cellular networks has enabled the implementation of new applications/services on a wide variety of electronic devices.

Cellular network operators may provide developers with access to application programming interfaces (APIs) that allow those developers to access and integrate advanced network capabilities like location data, network quality, and specific network features into their applications, enabling them to build innovative services based on cellular network functionalities. However, each application developed by such a developer must be tested across multiple systems that interact on the cellular network, which can be very time consuming and inefficient.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts an example environment in which one or more services may be implemented within a third-party software application in accordance with at least some embodiments.

FIG. 2 depicts an illustration of exemplary data structures representing two different exemplary models in accordance with embodiments.

FIG. 3 depicts a block diagram illustrating exemplary data structures that may be implemented as frameworks referenced in a data repository in accordance with embodiments.

FIG. 4 depicts a flow chart illustrating a first process for providing access to one or more services for implementation in a third-party software application in accordance with some embodiments.

FIG. 5 depicts a flow chart illustrating a second process for executing a service from a third-party software application in accordance with some embodiments.

FIG. 6 depicts an example of an architecture capable of implementing a quality on demand service within a wireless telecommunication network in accordance with some embodiments.

FIG. 7 depicts a flow diagram illustrating an exemplary process for enabling services to be invoked from a software application in accordance with at least some embodiments.

FIG. 8 shows an example computer architecture for a computing device capable of executing program components for implementing the functionality described above.

### DETAILED DESCRIPTION

This disclosure describes techniques that may be performed to optimize processes associated with the development of software applications operating on a cellular network. Cellular network operators typically maintain a number of services that can be accessed by an application developer for integration into a software application (e.g., via an API call). By integrating cellular APIs, developers can add features like location-based services, network performance monitoring, and quality-of-service management to their applications. With the advancement of 5G networks, APIs are increasingly integrated to provide access to advanced 5G features like network slicing, low-latency communication, and edge computing.

Some non-limiting examples of services that may be maintained by a cellular network operator for integration by developers (e.g., via a respective API) may include Location services that provide precise location data based on cell tower triangulation, Quality-on-Demand (QoD) services that allow developers to dynamically request specific network performance levels like low latency or high bandwidth depending on application needs, Network Slicing services that enable the creation of virtual networks with customized performance characteristics for specific use cases, and/or Device Authentication services that verify the authenticity of a mobile device on the network.

In embodiments, a common framework can be implemented with respect to each of a number of different charging models. Various instances of a framework are each issued a unique identifier (e.g., OfferID) as well as a service name as a flexible value. When implementing a service, a software application may submit a request that includes the unique identifier in order to invoke an API call associated with a requested service. Rather than requiring testing of each software application that utilizes a service across every impacted system, each framework can be tested and then reused by those software applications, resulting in a significant reduction in overall testing as well as time to market.

Embodiments of the disclosure provide for a number of advantages over conventional systems. For example, embodiments of the disclosed system allow for seamless onboarding of newly developed software applications while minimizing the time to market for those software applications. By implementing service calls via a common framework, new services can be introduced while reducing required testing for that service. Additionally, in conventional systems, user equipment may need to be updated/provisioned each time that a service is updated that is used by that user equipment. In embodiments of the disclosure, the user equipment need not be updated/provisioned when a service is updated as an API referenced by the user equipment is fungible.

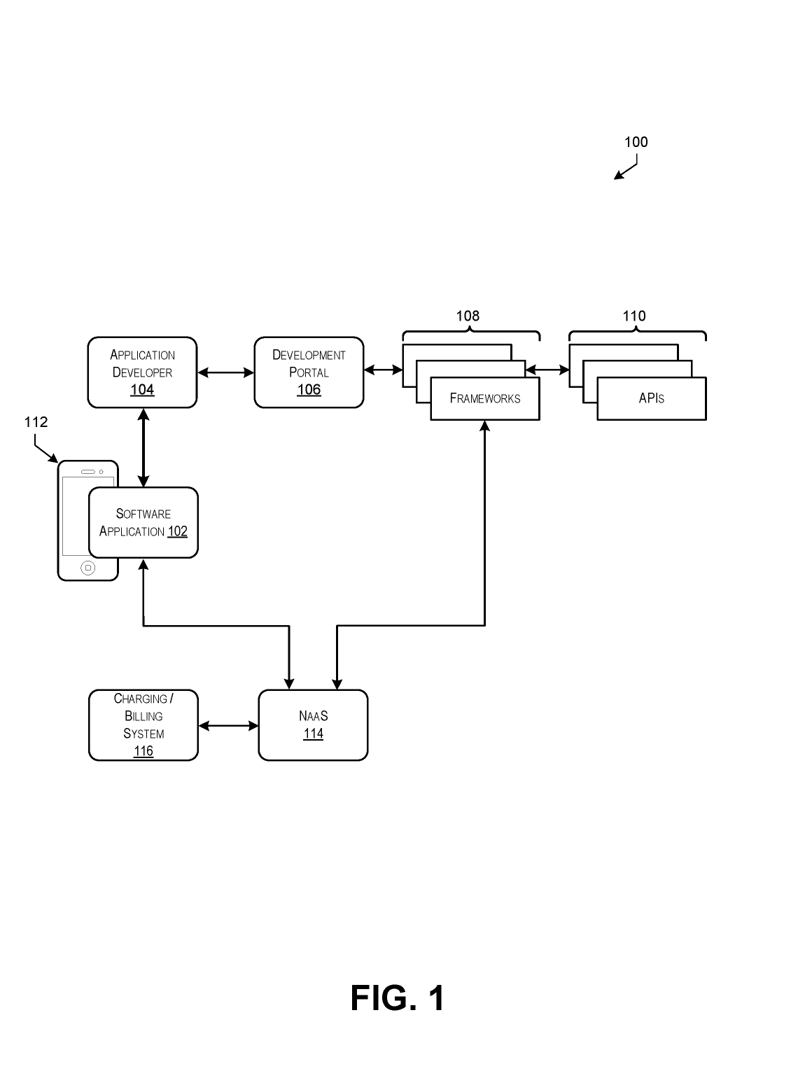

FIG. 1 depicts an example environment in which one or more services may be implemented within a third-party software application in accordance with at least some embodiments. As noted elsewhere, an application developer may provide a product offering (e.g., a software application 102) that utilizes one or more services made available on a network. In some cases, the application developer may operate a service provider server, which may be a computing device that provides backend services in support of such a software application 102. A “third-party” software application, for the purposes of this disclosure, is a software application that is developed and/or managed by a different entity than the entity that manages the network services that the software application seeks to use.

In embodiments, a development portal 106 manages access to a number of frameworks 108 that correspond to various services. Note that the various frameworks 108 may be indexed by a service identifier that uniquely identifies a predefined framework generated in relation to a particular service. In some cases, a range of service identifier values may be reserved for frameworks falling operating within predefined parameters. For example, ranges of service identifiers may be reserved for frameworks operating on different charging models. In this example, a first range of service identifier values may be reserved for frameworks operating on an “instant” charging model, a second range of service identifier values may be reserved for frameworks operating on an “time-based” charging model, and a third range of service identifier values may be reserved for frameworks operating on an “API Count” charging model.

Each framework dedicated to a service may include a service name for that service that correspond to one of the respective APIs 110. In some cases, each framework may include language and/or parameters for use in making a call to the respective API. When an application developer desires to implement a particular service within a software application, that application developer can be provided with a service identifier that corresponds to the desired service.

Once a software application 102 has been installed upon, and executed from, a user equipment 112, the user equipment 112 may be caused to establish communication (via a network, such as a cellular network) with a Network as a Service (NaaS) platform 114. During interactions between the software application 102 executing on the user equipment 112 and the NaaS platform 114, the software application may invoke a service by providing an indication of a corresponding service identifier.

Upon receiving a service identifier, the NaaS platform 114 may access the framework corresponding to the service identifier in order to execute the service via a call to a corresponding API. Each time that the NaaS accesses a service via the frameworks 108, the NaaS platform 114 may provide an indication of the service execution to a charging / billing system 116 so that the application developer 104 can be billed. In some cases, the NaaS platform 114 may provide the charging / billing system 116 with information about a charging model associated with execution of the service.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

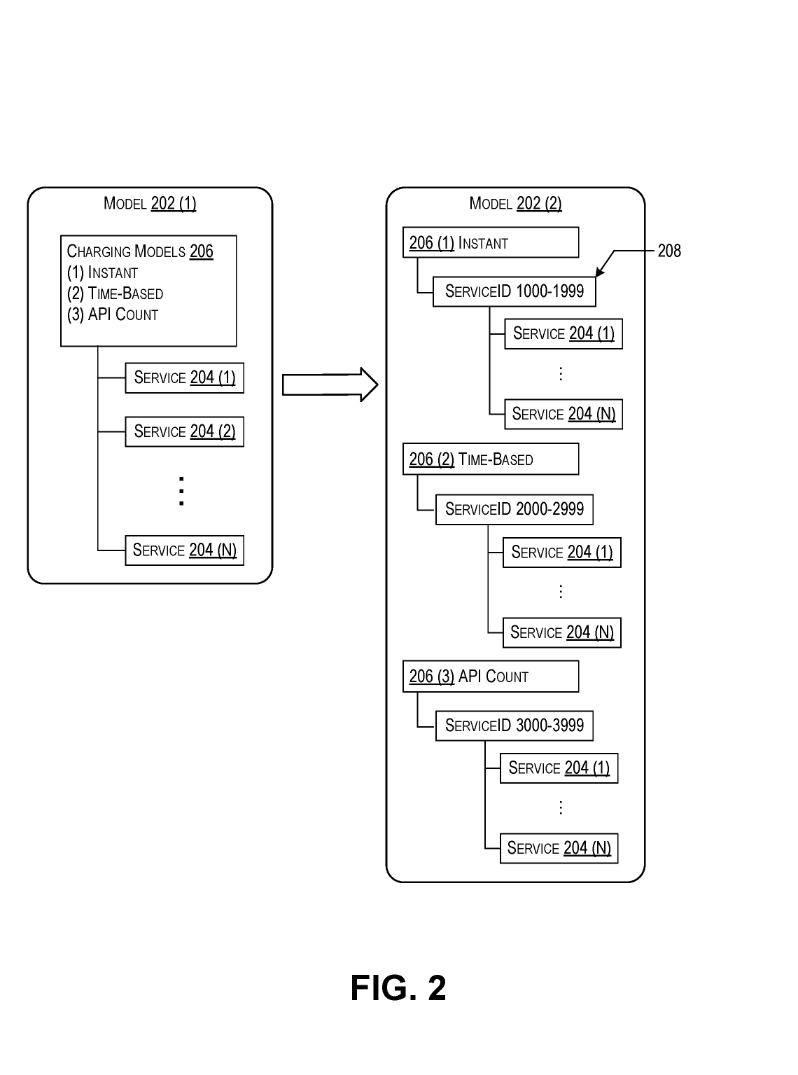

FIG. 2 depicts an illustration of exemplary data structures representing two different exemplary models in accordance with embodiments. Particularly, the two exemplary data structures represent a first (conventional) model 202 (1) and a second model 202 (2) structured in accordance with embodiments as disclosed.

In a conventional data structure as illustrated in model 202 (1), a number of services 204 (1 – N) can be implemented under a number of charging models 206. Notably, some such non-limiting examples of charging models 206 may include an instant charging model (206 (1)) in which a software owner is charged a set amount each time that the service is executed, a time-based charging model (206 (2)) in which a software owner is charged for an amount of time over which the service is executed, and an API count charging model (206 (3)) in which a software owner is charged based on a number of times that the API associated with a service is called. Note that while three such charging models 206 (1 – 3) are presented as exemplary in model 202 (1), those charging models 206 should be treated as non-limiting as alternative charging models may be used.

In the model 202 (1), each time that a service 204 is to be implemented by a customer (e.g., an application developer), an instance (e.g., a version) of the service will need to be implemented along with a specified charging model 206. In such cases, the particular combination of service and charging model will need to be tested across a number of platforms/systems, such as a Charging system, a Network Provisioning Engine (NPE), a Network as a Service (NaaS) platform, a Development Portal, and/or a Biller system before it can be implemented. Additionally, each time that a service is updated, the application developer will need to receive access to the new version of that service, which may further require updates to be made to the software application (and a downstream user equipment) via the NPE. This is especially true in cases in which the service name (and in some cases version) acts as a primary index to reference the service within a data repository (e.g., a service catalogue).

In embodiments of a data structure as illustrated in model 202 (2), a number of services 204 (1 – N) can be implemented via a common framework. Each framework can be customized to invoke a particular service under a particular charging model. In such cases, the set of frameworks may be segregated by at least one service identifier value such that a number of frameworks associated with a particular charging model may be assigned to a predetermined range of service identifier (e.g., ServiceID or OfferID) values 208. In the model 202 (2), the service identifier may act as a primary index for each framework related to a service of the services 204 (1 – N). Additionally, each framework related to a service of the services 204 (1 – N) may include an indication of a service name that corresponds to an application programming interface (API) that can be called to invoke the service. Note that, in embodiments, the service name may be a fungible value that can be updated each time that the respective service is updated.

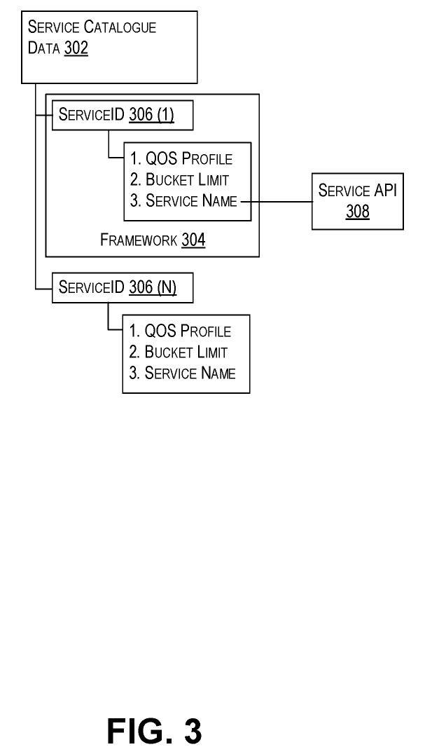

FIG. 3 depicts a block diagram illustrating exemplary data structures that may be implemented as frameworks referenced in a data repository in accordance with embodiments. In embodiments, such a data repository may be a repository of service catalogue data 302.

As noted elsewhere, each framework 304 may include various information related to implementation of a service. In some cases, each framework 304 may relate to implementation of the service under a predetermined charging model.

By way of non-limiting example, a framework associated with a service may include a service identifier, information related to a Quality of Service (QoS) profile, a bucket limit, and/or a service name / reference.

As noted above, a framework 304 may include a service identifier (e.g., ServiceID 306 (1 – N)) that uniquely identifies the service associated with the framework. As noted elsewhere, the service identifier may serve as an index value that is used to identify the framework 304.

In embodiments, a framework 304 may include QoS profile information that includes information about one or more quality standards to be maintained in relation to a service. For example, QoS profile information may include an indication of a minimum amount of available bandwidth or a maximum jitter/latency that can be used to implement the service. In some cases, such information may be derived from a Service Level Agreement (SLA) associated with the service to be provided. In some embodiments, the QoS profile information may include an indication of one or more channels (e.g., network slices) that can be used in relation to implementation of the service. It should be noted that this may facilitate channel enablement by storing an indication of the channels available for a service and charging model at the framework 304 itself.

In embodiments, the framework 304 may include a bucket limit that defines a quantity or period of time related to charging/billing instances of the service. The type or category of values represented by the bucket limit may vary based on a charging model associated with the framework 304. For example, if the framework 304 is associated with a time-based charging model, then the bucket limit information may include an indication of a maximum amount of time over which the service should be implemented for a billing block. Alternatively, if the framework 304 is associated with an API count charging model, then the bucket limit information may include an indication of a maximum number of times that an API for the service can be invoked for a billing block.

In embodiments, the framework may include a service name that corresponds to a service API 308 that can be used to invoke the respective service. Because the service name is not used as a primary index in the service catalogue data 302, it should be recognized that the value stored as the service name is fungible, in that it may be updated when a new version of the service becomes available, allowing for seamless updating of services without the need to make updates to the downstream software application or user equipment. In embodiments, the framework 304 may maintain a formatted API call that can be invoked to access the service API 308 in order to access the respective service.

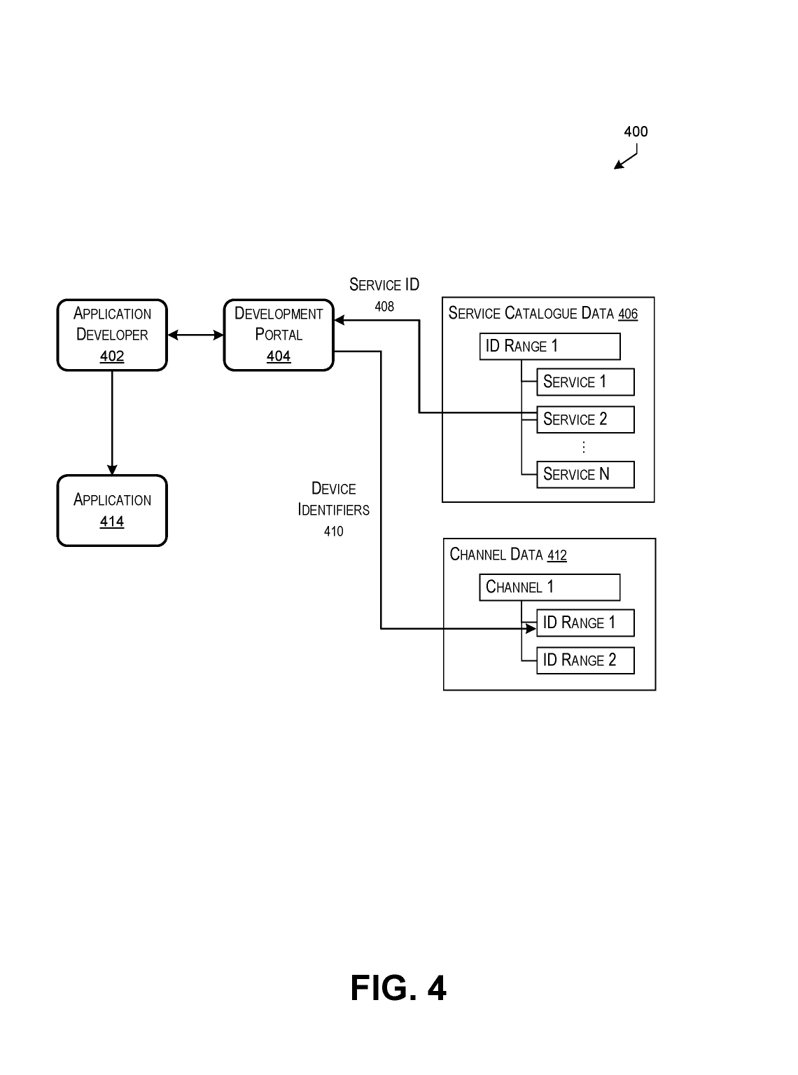

FIG. 4 depicts a flow chart illustrating a first process for providing access to one or more services for implementation in a third-party software application in accordance with some embodiments. In embodiments, the first process 400 may be an onboarding process in which a customer (e.g., a software application developer) requests and receives access to a service offered in relation to a network (e.g., a cellular network).

As noted elsewhere, an application developer 402 may request access to a service managed by a network provider via a development portal 404. In some cases, the application developer 402 provides an indication of at least one user equipment identifier that corresponds to a number of user equipment. Notably, an application developer may maintain/operate one or more applications executing on an Internet of Things (IoT) device that operates on a network in order to provide a specific service/function. In such cases, the application developer 402 may provide a range of device identifiers that are reserved for that IoT device. In some cases, an exemplary device identifier may be a Mobile Station International Subscriber Directory Number (MSISDN) that uniquely identifies electronic devices that operate on a cellular network.

Upon receiving a request to access a service, the development portal 404 may determine an appropriate charging model to be associated with the requested service and the application developer 402. In some cases, such a determination may be made based on a type or category of application that will invoke the service. For example, a service to be invoked by a user device performing gaming operations may relate to a different charging model than a service to be invoked by a user device performing video streaming operations. In some cases, such a determination may be made based on an indication of a charging model received from the application developer 402.

Once an appropriate charging model and service have been determined, the development portal 404 may identify a relevant framework from service catalogue data 406 that it maintains. In some cases, the service catalogue data 406 may be stored as a local data repository. In other cases, the service catalogue data 406 may be stored at a separate (e.g., remote) computing device/server. In embodiments, a framework related to the requested service may be identified by virtue of being associated with a determined charging model. For example, a number of different frameworks may be associated with a single service, with each of those individual frameworks each also being associated with a different charging model. As noted elsewhere, a range of service identifiers may be assigned to a charging model, such that frameworks associated with different charging models may be identified based on their service identifier falling within a range associated with the respective charging model.

Once the development portal 404 has identified an appropriate framework based on the requested service, the development portal 404 may retrieve a service identifier associated with that framework to be provided back to the application developer 402. The application developer 402 may then configure an application (e.g., a software application) to present the service identifier 408 to a network in order to invoke the relevant service.

In embodiments, and as noted above, the application developer 402 may provide a list of device identifiers 410 to the development portal 404 to be associated with the service. As noted elsewhere, a framework associated with a service may include a QoS profile that stores an indication of one or more channels that are authorized to be used in relation to the service. Upon receiving a list of device identifiers 410, the development portal may update a repository of channel data 412 that correlates channels to device identifiers that are authorized to use those channels. For example, the development portal 404 may, in response to a request to access a service, identify one or more channels associated with that service and then update channel data 412 to indicate that device identifiers associated with that request are now authorized to use the one or more channels.

Upon receiving an indication of the service ID 408 from the development portal 404, an application developer 402 may implement that service ID 408 within an application 414 to be installed on, and executed from, a user device. One implemented in this manner, the application may provide the service ID 408 to a NaaS platform in order to invoke a service. In such cases, the application 414 may provide the service ID 408 to the NaaS platform instead of making an API call related to the service, which then results in the NaaS platform making the API call on behalf of the application 414.

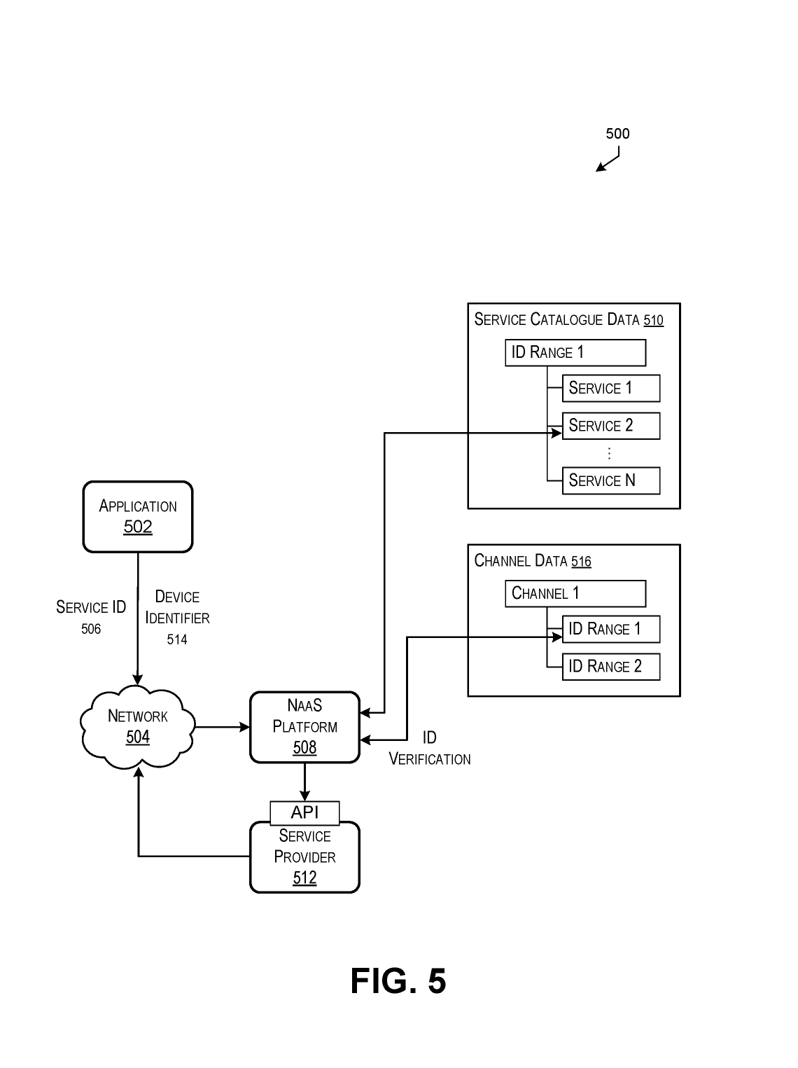

FIG. 5 depicts a flow chart illustrating a second process for executing a service from a third-party software application in accordance with some embodiments. In embodiments, the second process 500 may be runtime process in which an application 502 (e.g., a software application) invokes a service offered in relation to a network (e.g., a cellular network).

In embodiments, an application 502 may execute on a user device that is operating on network 504. During execution, the application 502 may provide a service ID 506 to the network 504 in order to invoke a service associated with that service ID 506. The network 504 may then provide the received service ID 506 to a Network as a Service (SaaS) platform 508. The NaaS platform 508 may subsequently identify a framework associated with the service ID 506 based on information stored in a service catalogue data 510. As noted elsewhere, a service ID value may act as a primary index for frameworks stored in service catalogue data 510. In such cases, the frameworks in the service catalogue data 510 may be delineated based on charging model, in that a charging model may be associated with a range of service ID values.

Upon identifying a framework from the service catalogue data 510, the NaaS platform 508 may retrieve a service name value stored in relation to that framework. The NaaS platform 508 may then invoke the service associated with the service name value. In embodiments, this may involve submitting a request to a service provider 512 associated with the service to be provided. In such embodiments, the request may be submitted via a call to an API associated with the service.

The service provider 512, upon receiving the request from the NaaS platform 508 to invoke a service, may then execute the requested service and provide any output resulting from such execution to the application 502 via the network 504.

In some cases, the NaaS Platform 508 may be further configured to perform a verification process before invoking a service. For example, if the requested service is a QoD service that would require the use of a particular channel, the NaaS platform 508, before invoking that QoD service, may verify that the user device on which the application 502 is executing is authorized to use the particular channel. In embodiments, the application 502 may provide a device identifier 514 during its execution. In such cases, an ID verification process may be performed by comparing the device identifier 514 against a list of device identifiers stored in channel data 516 as being authorized to use the channel. In some cases, the channel data 516 may store an indication of a range of device identifiers that are authorized to use each of a number of channels.

In embodiments in which the requested service is a QoD service, the service provider 512 may, upon executing the service, configure the network 504 to cause network traffic directed to and from the application 502 to be transmitted over the appropriate channel (e.g., network slice).

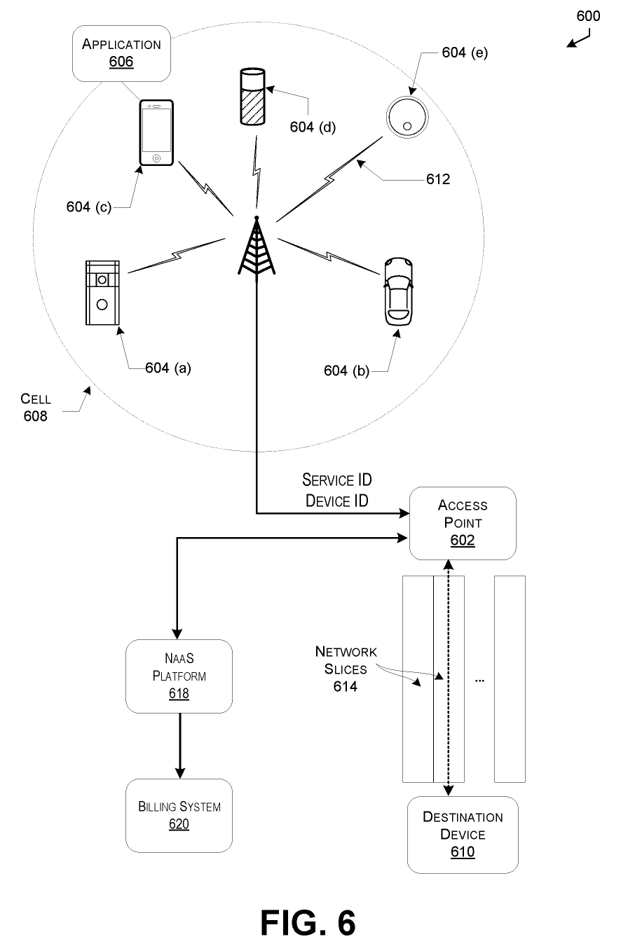

FIG. 6 depicts an example of an architecture capable of implementing a quality on demand service within a wireless telecommunication network in accordance with some embodiments.

A network 600 may include at least one access point 602 that is configured to perform a Quality on Demand (QoD) function. An access point 602 may be any computing device that provides ingress/egress to the network. In some embodiments, the access point 602 may be, or may be implemented within, a base station (e.g., access point 602).

A base station is a type of network access node (NAN) that can also be referred to as a cell site, a base transceiver station, or a radio base station. In some embodiments, the access point 602 may include one or more radio access units that provide service (e.g., cellular data service) to a user device 604 within a cell 608 that defines a geographic area. The network 600 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The access points forming the network 600 may communication with a number of user devices. For example, access point 602 may be in communication with user devices 604 (a - e). Additionally, a group of neighboring base stations / access points 602 may be managed by a base station controller (not shown) in order to provide access to a network.

An access point 602 implemented as a base station may include one or more transmission mechanisms (e.g., a radio transceiver) capable of enabling wireless communication with a number of user devices. Such base stations may be distributed over an area in a sufficiently dense manner such that user devices (e.g., mobile communication devices) in communication with the network can communicate with each other or with a terrestrial network. In some embodiments, the access point 602 may include one or more sensors configured to collect information about the access point 602 itself or an environment in which the access point 602 is situated. Additionally, the access point 602 may include one or more mechanical means of adjusting/configuring components of the equipment node. For example, the equipment node may include a radio antenna as well as a motorized mechanism for adjusting a position of the radio antenna.

An access point 602 implemented as a base station can wirelessly communicate with the user devices 604 within a cell 608 via one or more base station antennas. A cell 608 associated with an access point 602 can be divided into sectors making up only a portion of the cell (not shown). The network 600 can include base stations of different types (e.g., macro and/or small cell base stations). In some implementations, there can be overlapping geographic coverage areas (cell 608) for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.). In some embodiments, the access point 602 communicates with the user devices 604 via a fixed wireless access (FWA) connection. FWA is a type of 5G or 4G LTE wireless technology that enables fixed broadband access using radio frequencies rather than cables.

The user devices 604 (a - e) can correspond to or include devices capable of communication using various connectivity standards. For example, a 5G communication channel can use millimeter wave (mmW) access frequencies of 28 GHz or more. In some implementations, a user device 604 can operatively couple to an access point 602 over a long-term evolution/long-term evolution-advanced (LTE/LTE-A) communication channel, which is referred to as a 4G communication channel. In some non-limiting examples, user devices can include handheld mobile devices (e.g., smartphones, portable hotspots, tablets, etc.); laptop devices; wearable devices; drones; vehicles with wireless connectivity; head-mounted displays with wireless augmented reality/virtual reality (AR/VR) connectivity; portable gaming consoles; wireless routers, gateways, modems, and other fixed-wireless access devices; wirelessly connected sensors that provides data to a remote server over a network; IoT devices such as wirelessly connected smart home appliances, etc.

A user device 604 may be any electronic device that can communicate with various types of access points and network equipment at the edge of a network 600 including macro eNBs/gNBs, small cell eNBs/gNBs, relay base stations, and the like. A user device 604 can also communicate with other user devices 604 either within or outside the same coverage area of a base station via device-to-device (D2D) communications. In some cases, a user device 604 may be an IoT device that operates on a network (e.g., a cellular network) to provide a specific service/function.

The communication link 612 between a user device 604 and an access point 602 may include uplink (UL) transmissions from a user device 604 to an access point 602, and/or downlink (DL) transmissions from an access point 602 to a user device 604. The downlink transmissions can also be called forward link transmissions while the uplink transmissions can also be called reverse link transmissions. Each communication link includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links can transmit bidirectional communications using frequency division duplex (FDD) (e.g., using paired spectrum resources) or Time division duplex (TDD) operation (e.g., using unpaired spectrum resources). In some implementations, the communication links include LTE and/or mmW communication links.

User device 604 may include a number of software applications 606, each of which, when executed, may cause the user device to transmit a number of data packets over the network 600. In some cases, the number of data packets may be directed by the user device 604 to a target destination device 610. For example, given that a software application is supported by a remote server, the software application may cause the user device to send data packets to that remote server. A destination device 610 may include any suitable computing device configured to receive network data as implemented herein.

In embodiments, the access point 602 (or another suitable gateway device) may be configured to allocate a sequence of data packets received from a user device 604 to a specified network slice 614. More particularly, a network 600 may consist of a number of network slices 614, each of which are dedicated to a type or category of network traffic. As noted elsewhere, the network 600 may be partitioned into a number of network slices 614, with each of the individual network slices consisting of one or more bandwidth parts dedicated to a type of network traffic. For example, one network slice 614 of the number of network slices may be a range of bandwidth frequencies that is dedicated to communicating data packets between Internet of Things (IoT) devices to their respective support servers. The use of network slices to communicate dedicated traffic generally allows for the network slice to be optimized for that type of traffic. More particularly, each network slice may be configured to accommodate a particular type of network traffic. By way of illustration, one network slice may be configured to optimize transmission of network traffic that requires significant bandwidth but is not latency-sensitive (e.g., download network traffic). Another network slice may be configured to optimize transmission of network traffic that is latency sensitive. In some cases, a default network slice may be maintained that is configured to handle a variety of different network traffic types without optimizing any particular aspect.

In embodiments, an application 606 may invoke a QoD service which causes an access point 602 to allocate network traffic for that application to an optimal network slice. In such embodiments, the application 606 may provide, along with such network traffic, an indication of a service identifier associated with the QoD service to be executed along with a device identifier that uniquely identifies the user device (e.g., an MSISDN). In embodiments, the access point 602 may forward at least a portion of the information provided in relation to the invocation of the QoD service to a NaaS platform 618. The NaaS platform 618 may initially check the device identifier against those authorized to access the service in order to make a determination as to whether the service is authorized to be accessed.

Provided that the NaaS platform 618 makes a determination that the requested service (e.g., the QoD service) is authorized, the NaaS platform 618 may then perform channel identification. More particularly, the NaaS platform 618 may identify one or more channels (e.g., network slices) that are authorized to be used in relation to the service. Such channels authorized to be used in relation to a service may be indicated within a QoS profile stored in relation to the service (e.g., within a framework). In this exemplary scenario, the NaaS platform 618 may provide a response to the access point 602 that includes an indication of one or more channels that can be used by the application based on the invoked QoD service.

The access point 602 may, upon receiving the indication of one or more channels from the NaaS platform 618, may select a network slice 614 to be allocated to the network traffic originating from the application 606. In some cases, the access point 602 may select a network slice from the one or more channels based on aspects of the network slice. For example, the access point 602 may select a network slice from a set of network slices 614 indicated as being authorized based on a current load on each of those network slices. In this example, the access point 602 may select the network slice for allocation that currently has the lightest load or the least lag/latency. In some embodiments, the application 606 may provide an indication of a network slice identifier to which the application’s traffic should be allocated. In such embodiments, the access point 602 may make a determination as to whether the indicated network slice is within the one or more channels indicated by the NaaS platform 618. Provided that the requested network slice is within the one or more channels, the access point 602 may allocate network traffic originating from the application 606 to that network slice for a period of time.

In embodiments, once the QoD service has been invoked and the access point 602 has allocated the network traffic for an application based on that QoD service, information about the QoD service may be provided to a billing system 620 so that the operator of the application 606 can be billed appropriately based on the use of the service.

The network 600 can include a 5G network and/or an LTE/LTE-A or other network. In an LTE/LTE-A network, the term eNB is used to describe the access points 602, and in 5G new radio (NR) networks, the term gNBs is used to describe the access points 602 that can include mmW communications. The network 600 can thus form a heterogeneous network 600 in which different types of base stations provide coverage for various geographic regions. For example, each access point 602 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by user devices that have service subscriptions with a wireless network 600 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by user devices that have service subscriptions with the network 600 provider. A femto cell covers a relatively smaller geographic area (e.g., a home) and can provide restricted access by user devices having an association with the femto unit (e.g., user devices in a closed subscriber group (CSG), user devices for users in the home). A base station can support one or multiple (e.g., two, three, four, and the like) cells (e.g., component carriers). All fixed transceivers noted herein that can provide access to the network 600 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a user device 604 and the access points 602 or core network supporting radio bearers for the user plane data. At the Physical (PHY) layer, the transport channels are mapped to physical channels.

The illustrative network 600 may incorporate, by way of example, CDMA2000 based mobile wireless network components (e.g., AAA service for performing user authentication and providing user profiles) and includes data services delivered via one or more data access protocols, such as EV-DO, EV-DV or the like. Other embodiments include a wireless access network complying with one or more of LTE, WCDMA, UMTS, GSM, GPRS, EDGE, Wi-Fi (i.e., IEEE 802.11x), Wi-MAX (i.e., IEEE 802.16), or similar telecommunication standards configured to deliver voice and data services to mobile wireless end user devices such as, a user device 604 depicted in FIG. 1 carrying out wireless communications via an access point 602. Such a mobile wireless network system may include hundreds or thousands of such base stations.

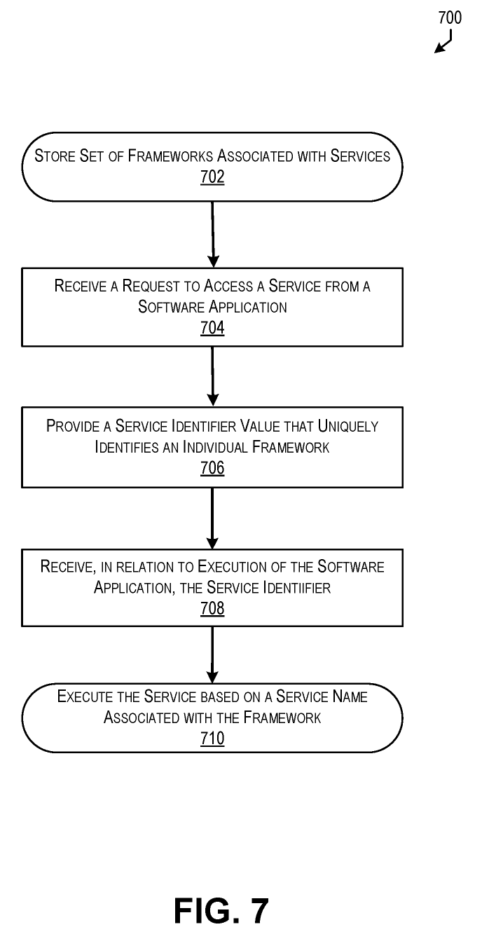

FIG. 7 depicts a flow diagram illustrating an exemplary process for enabling services to be invoked from a software application in accordance with at least some embodiments. The process 700 may be performed by a Network as a Service (NaaS) platform, such as the NaaS Platform 114 as described in relation to FIG. 1 above.

At 702, the process 700 may involve storing, in a data repository, a set of frameworks associated with services in which an individual framework of the set of frameworks is associated with a service. In some embodiments, the individual framework is associated with a charging model. In some cases, the set of frameworks are segregated by at least one service identifier value based on an associated charging model. For example, a subset of the set of frameworks associated with an individual charging model may be assigned a range of service identifier values.

At 704, the process 700 may involve receiving a request to access the service from a software application. In embodiments, the request to access the service may be received from a computing device of an application developer via a development portal.

At 706, the process 700 may involve providing, in response to the request, a service identifier value that uniquely identifies the individual framework to the computing device of the application developer. In some embodiments, a device identifier may also be received with the request in relation to the service identifier. In some cases, the process may further involve verifying that the application is authorized to access the service based on whether the device identifier is included in a list of device identifiers authorized to invoke that service.

At 708, the process 700 may involve receiving, from the software application during its execution, the service identifier value. In embodiments, the application is executed from a user equipment operating on a cellular network that provides the service.

At 710, the process 700 may involve executing the service based on a service name associated with the individual framework. In embodiments, the service name associated with the individual framework corresponds to an application programming interface for the service. Executing the service may involve identifying an application programming interface (API) associated with the service and performing an API call associated with that API. In some cases, the API is identified based on a service name value associated with the individual framework.

In an exemplary embodiment, the service requested by the application may be a quality on demand (QoD) service. In this exemplary embodiment, executing the service may involve causing network traffic associated with the application to be transmitted over a specified channel.

In embodiments in which the framework is associated with a charging model, the process may further involve providing information related to the execution of the service to a charging system based on the charging model. The charging system may then aggregate that information, along with other information about the execution with the service, into billing data.

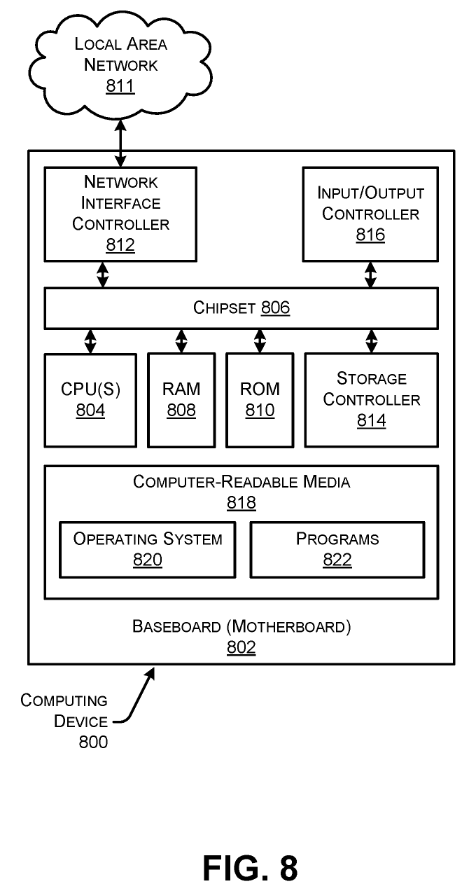

FIG. 8 shows an example computer architecture for a computing device 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computing device 800 may, in some examples, correspond to a physical server as described herein, and may comprise networked devices such as servers, switches, routers, hubs, bridges, gateways, modems, repeaters, access points, etc.

The computing device 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computing device 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computing device 800. The chipset 806 can further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM can also store other software components necessary for the operation of the computing device 800 in accordance with the configurations described herein.

The computing device 800 can operate in a networked environment using logical connections to remote computing devices and computer systems through a network, such as the network 811. The chipset 806 can include functionality for providing network connectivity through a NIC 812, such as a gigabit Ethernet adapter. The NIC 812 is capable of connecting the computing device 800 to other computing devices over the network 811. It should be appreciated that multiple NICs 812 can be present in the computing device 800, connecting the computer to other types of networks and remote computer systems.

The computing device 800 can be connected to a storage device 818 that provides non-volatile storage for the computer. The storage device 818 can store an operating system 820, programs 822, and data, which have been described in greater detail herein. The storage device 818 can be connected to the computing device 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computing device 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 can further read information from the storage device 818 by detecting the physical states or characteristics of one or more particular locations within the physical storage units.

In addition to the mass storage device 818 described above, the computing device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 800. In some examples, the operations performed by devices as described herein may be supported by one or more devices similar to computing device 800. Stated otherwise, some or all of the operations performed by an edge device, and/or any components included therein, may be performed by one or more computer device 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computing device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computing device 800.

In one embodiment, the storage device 818 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs 804 transition between states, as described above. According to one embodiment, the computing device 800 has access to computer-readable storage media storing computer-executable instructions which, when executed by the computing device 800, perform the various processes described above with regard to the other figures. The computing device 800 can also include computer-readable storage media having instructions stored thereupon for performing any of the other computer-implemented operations described herein.

The computing device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computing device 800 might not include all of the components shown in FIG. 8, can include other components that are not explicitly shown in FIG. 8, or might utilize an architecture completely different than that shown in FIG. 8.

As described herein, the computing device 800 may include one or more hardware processors 804 (processors) configured to execute one or more stored instructions. The processor(s) 804 may comprise one or more cores. Further, the computing device 800 may include one or more network interfaces configured to provide communications between the computing device 800 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 811. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 822 may comprise any type of programs or processes to perform the techniques described in this disclosure. The programs 822 may comprise any type of program that cause the computing device 800 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate–System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause computing device 800 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M = a * x + b * y + c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k–NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
storing, in a data repository, a set of frameworks, an individual framework of the set of frameworks associated with a service;
receiving a request to access the service from an application;
providing, in response to the request, at least one service identifier value that uniquely identifies the individual framework;
receiving, from the application during its execution, the at least one service identifier value; and
executing the service based on a service name associated with the individual framework.

2. The method of claim 1, wherein the individual framework is associated with a charging model.

3. The method of claim 2, further comprising providing information related to the executing the service to a charging system based on the charging model.

4. The method of claim 1, wherein the set of frameworks are segregated by the at least one service identifier value based on an associated charging model.

5. The method of claim 4, wherein a subset of the set of frameworks associated with an individual charging model are assigned a range of service identifier values.

6. The method of claim 1, wherein the service name associated with the individual framework corresponds to an application programming interface for the service.

7. The method of claim 1, wherein the request to access the service is received from a computing device of an application developer via a development portal.

8. The method of claim 1, wherein the service comprises a quality on demand (QoD) service.

9. The method of claim 8, wherein executing the service comprises causing network traffic associated with the application to be transmitted over a specified channel.

10. A computing device comprising:
one or more processors; and
one or more non-transitory computer-readable media storing computer-executable instructions that, when executed by the one or more processors, cause computing device to perform operations comprising:
maintaining a set of frameworks, an individual framework of the set of frameworks associated with a service;
providing at least one service identifier value that uniquely identifies an individual framework to a computing device of an application developer for implementation into an application;
receiving, from the application during its execution, the at least one service identifier value; and
executing the service based on a service name associated with the individual framework.

11. The computing device of claim 10, wherein executing the service comprises identifying an application programming interface (API) associated with the service and performing an API call associated with that API.

12. The computing device of claim 11, wherein the API is identified based on a service name value associated with the individual framework.

13. The computing device of claim 10, wherein the operations further comprise receiving a device identifier associated with a user device on which the application is executing.

14. The computing device of claim 13, wherein the operations further comprise verifying that the application is authorized to access the service based on the device identifier.

15. The computing device of claim 14, wherein the verifying that the application is authorized to access the service comprises verifying that the device identifier is included in a list of device identifiers associated with the service.

16. The computing device of claim 10, wherein the application is executed from a user equipment operating on a cellular network that provides the service.

17. One or more non-transitory computer-readable media storing computer-executable instructions that, when executed by one or more processors, cause the one or more processors to perform operations comprising:
maintaining a set of frameworks, an individual framework of the set of frameworks associated with a service;
providing at least one service identifier value that uniquely identifies an individual framework to a computing device of an application developer for implementation into an application;
receiving, from the application during its execution, the at least one service identifier value; and
executing the service based on a service name associated with the individual framework.

18. The one or more non-transitory computer-readable media of claim 17, wherein executing the service comprises identifying an application programming interface (API) associated with the service and performing an API call associated with that API, and wherein the API is identified based on a service name value associated with the individual framework.

19. The one or more non-transitory computer-readable media of claim 17, wherein the operations further comprise receiving a device identifier associated with a user device on which the application is executing and verifying that the application is authorized to access the service based on the device identifier.

20. The one or more non-transitory computer-readable media of claim 17, wherein the set of frameworks are segregated by at least one service identifier value based on an associated charging model.
